(19) United States
(12) Patent Application Publication
(10) Pub. No.: US 2006/0042034 A1
(43) Pub. Date: Mar. 2, 2006

(54) Cleaning device

(76) Inventor: Fari Maissami, Hinsdale, IL (US)

Correspondence Address: Pauley Petersen & Erickson, Suite 365, 2800 West Higgins Road, Hoffman Estates, IL, 60195, US

(21) Appl. No.: 10/991,753

(22) Filed: Nov. 18, 2004

Related U.S. Application Data
(60) Provisional application No. 60/604,978, filed on Aug. 27, 2004.

(51) Int. Cl. A61C 15/00; A46B 9/04

(52) U.S. Cl. 15/167.1; 132/321

(57) ABSTRACT

A cleaning device including a handle portion transitioning into a tip portion. The tip portion includes a back wall and two opposing tapered side walls connected to the back wall and forming an edge along a length of the tip portion. The opposing side walls converge from a base of the tip portion to a point of the tip portion. Preferably, a plurality of bristles coat the edge and at least a portion of each of the opposing side walls. The back wall is free of or void of bristles. At least one indentation is formed in the cleaning device, for example on the handle portion, so that the tip portion is bendable with respect to the handle portion at the indentation.

### BACKGROUND OF THE INVENTION

This invention relates generally to device for cleaning teeth and, more particularly, to a cleaning device for cleaning tooth surfaces and/or interdental areas between adjacent teeth.

Flossing devices are generally used throughout the dental profession and by consumers to clean tooth surfaces, particularly tooth surfaces forming or defining the space or area between adjacent teeth, commonly referred to as an interdental space or area.

Many conventional flossing devices include a plastic projection that penetrates in between teeth, and into the interdental space. The flossing device is slid or moved with respect to the adjacent tooth surfaces and the gum line to clean the tooth surfaces and the interdental space between the tooth surfaces. While these conventional flossing devices can fit within the interdental space, they may not adequately clean the tooth surfaces and/or the interdental space.

Other conventional flossing devices may include a thin wire having bristles cylindrically integrated within the wire. These conventional flossing devices are only suitable for larger interdental areas and may irritate the gum line. For example, because the bristles extend radially from the wire, the bristles form a generally cylindrical brush that does not correspond to the natural anatomy of the interdental spaces. Thus, the bristles frictionally interfere with and/or undesirably contact the gum line to irritate the sensitive gum areas. Further, the large diameter of these conventional flossing devices prevents the device from penetrating into relatively smaller interdental spaces.

### SUMMARY OF THE INVENTION

It is one object of this invention to provide an improved cleaning device.

It is another object of this invention to provide a cleaning device for cleaning interdental spaces and the tooth surfaces defining the interdental spaces, without irritating the surrounding gum areas.

The above and other objects of the invention can be attained through a cleaning device including a handle portion that transitions into or is connected to a tip portion. The tip portion preferably includes opposing tapered side walls connected to a back wall and extending from the back wall to form an angled edge along a length of the tip portion. Preferably, the opposing side walls converge from a base of the tip portion towards a point of the tip portion.

A plurality of bristles are preferably disposed at the tip portion of the device, for example using a flocking procedure. It is apparent to those skilled in the art that other suitable procedures may be used to coat or flock at least a portion of the tip portion with bristles. At least a portion of the edge and at least a portion of one or both opposing side walls are preferably coated or flocked with a plurality bristles, while the back wall is void of any bristles. The back wall generally corresponds to or is positioned with respect to the user's gum line. Because the back wall is void of bristles, contact between the back wall and the gum line or gum areas during use of the cleaning device will not irritate the user's gum areas.

In one preferred embodiment of this invention, at least one indentation is formed in the cleaning device, for example in a body or handle portion of the cleaning device. Preferably, a plurality of indentations are formed in the handle portion to allow the cleaning device to be bent into a desired configuration or position. Each indentation preferably but not necessarily includes opposing pillars or ridges defining or surrounding the indentation. The ridges may work as a “locking notch” when the device is bent, as desired. The locking notch maintains the cleaning device in the desired bent position, when pressure is applied to the cleaning device during use.

For example, in one preferred embodiment of this invention, the handle portion may include two or more indentations in separate areas of the handle portion. A first indentation allows the user to bend the cleaning device at the first indentation in order to position the tip portion to fit along a left side of the user's mouth. The user is then able to position the tip portion within selected interdental areas and/or along selected tooth surfaces to clean the teeth. Similarly, a second indentation allows the user to bend the device at the second indentation in order to position the tip portion to fit along an opposing right side of the user's mouth and position the tip portion within selected interdental areas and/or along selected tooth surfaces to clean the interdental spaces and/or the teeth.

In one preferred embodiment of this invention, a series of adjacent indentations formed on the cleaning device handle portion allow the user to make successive bends to configure the cleaning device as desired. Each indentation can be bent independently to allow the cleaning device handle portion to be configured as desired. Such indentations on the handle portion can be useful for reaching the posterior areas of the mouth. Additionally, the multiple bending capability of the cleaning device is useful for reaching the upper anterior area, as well as the lower anterior area of the mouth from a lingual direction.

Other objects and advantages of this invention are apparent to those skilled in the art, in view of the following detailed description taken in conjunction with the appended claims and drawings.

### BRIEF DESCRIPTION OF THE DRAWINGS

FIG. 1 is a perspective view of a cleaning device, according to one preferred embodiment of this invention;

FIG. 2 is a side view of the cleaning device shown in FIG. 1;

FIG. 3 is a top view of the cleaning device shown in FIG. 1;

FIG. 4 is a front view of the cleaning device shown in FIG. 1;

FIG. 5 is a bottom view of the cleaning device shown in FIG. 1; and

FIG. 6 is a side view of a cleaning device, according to another preferred embodiment of this invention.

### DETAILED DESCRIPTION OF THE INVENTION

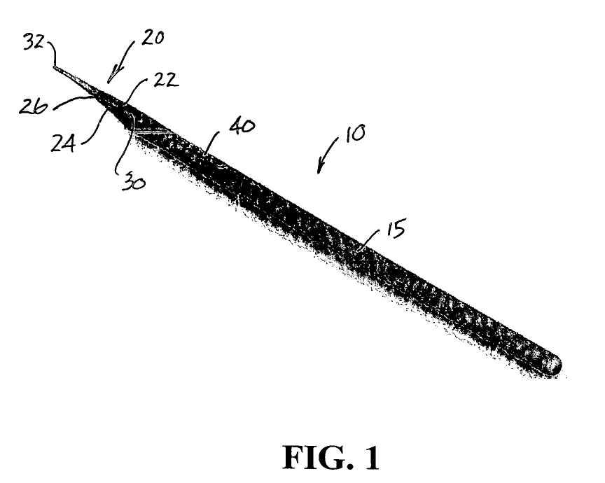

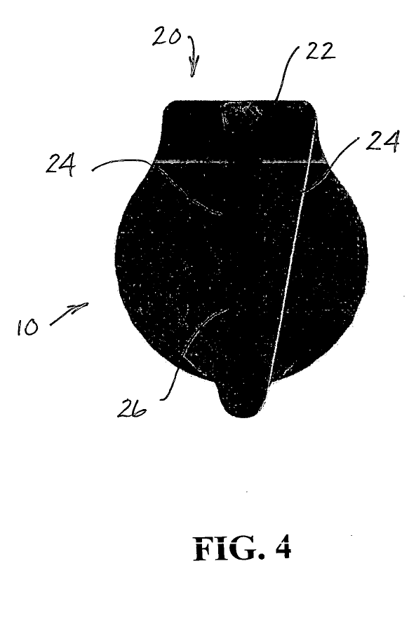

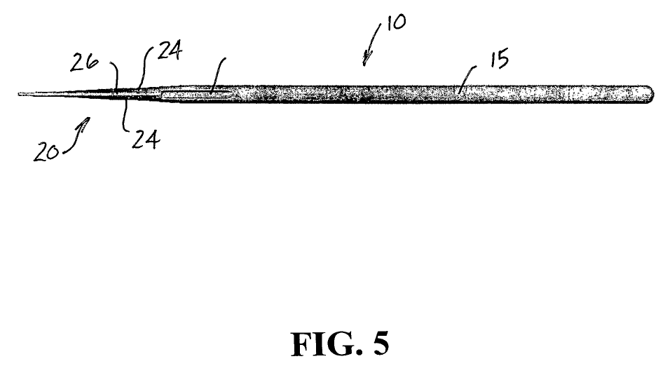

Referring to FIGS. 1-6, the present invention provides a cleaning device 10 including a body or handle portion 15 transitioning into or connected to a tip portion 20. In one preferred embodiment of this invention, cleaning device 10 includes an elongated handle having a tip formed at a distal end of the handle. Tip or tip portion 20 is preferably integrated with the elongated handle or handle portion 15. Alternatively, tip portion 20 can be made as an independent piece that is connected to handle portion 15 using a suitable connection. For example, tip portion 20 can be molded, using a suitable injection molding procedure, to include a threaded portion that can be threadedly attached or connected to a cooperating portion of handle portion 15. Further, tip portion 20 is separable from the elongated handle or handle portion 15.

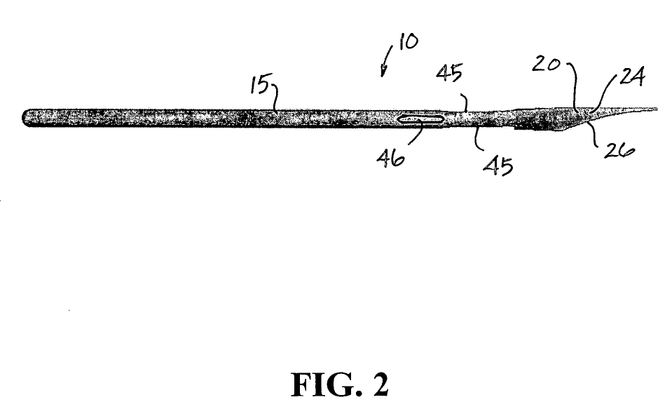

Tip portion 20 includes a back wall 22 and two opposing side walls 24 connected at opposing side edges of back wall 22. Each side wall 24 is connected to back wall 22 along a length of tip portion 20, as shown in FIGS. 1-3. Side walls 24 converge or join to form an angled edge 26 along the length of tip portion 20. As shown for example in FIG. 2, edge 26 has an arcuate shape. Alternatively, edge 26 can have a generally linear shape, wherein a perpendicular distance between back wall 22 and edge 26 increases from a point of tip portion 20 to a base of tip portion 20. It is apparent to those skilled in the art and guided by the teachings herein provided that edge 26 can have any suitable profile and/or shape so that tip portion 20 can be positioned within an interdental space.

In one preferred embodiment of this invention, opposing side walls 24 converge from a base 30 of tip portion 20 to a point 32 of tip portion 20. Point 32 allows cleaning device 20 to be positioned properly within interdental spaces, particularly relatively small interdental spaces, to clean the interdental spaces and/or the adjacent tooth surfaces defining or forming the interdental spaces.

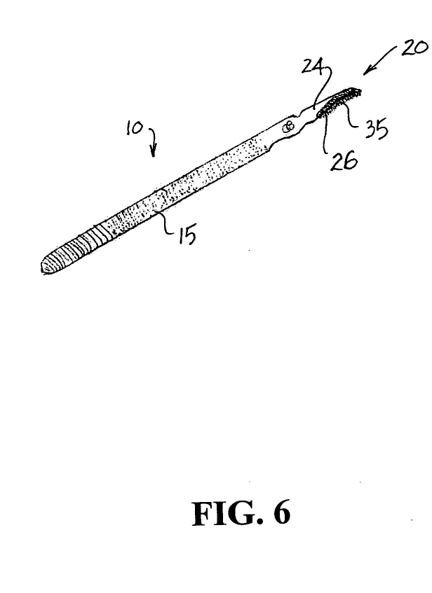

In one preferred embodiment of this invention, a plurality of bristles 35 are disposed on tip portion 20, as shown in FIG. 6. Preferably, cleaning device 10 shown in FIGS. 1-5 include bristles 35 disposed on tip portion 20. However, for clarity purposes, cleaning device 10 as shown in FIGS. 1-5 does not include bristles 35 disposed on or coating at least a portion of tip portion 20. Preferably, bristles 35 are disposed along at least a portion of a length of edge 26 and at least a portion of each side wall 24. However, unlike conventional cleaning devices discussed above, back wall 22 preferably includes a generally smooth surface free of or void of bristles 35. Because back wall 22 is void of bristles 35, back wall 22 is generally smooth and, thus, as back wall 22 contacts a user's gum areas, the gum areas are not irritated by bristles 35 as cleaning device 10 is moved with respect to the interdental space and/or the adjacent tooth surfaces defining the interdental space. Bristles 35 can be disposed on tip portion 20 using any suitable method or procedure, such as a flocking procedure that coats at least a portion of the length of edge 26 and/or at least a portion of one or both opposing side walls 24.

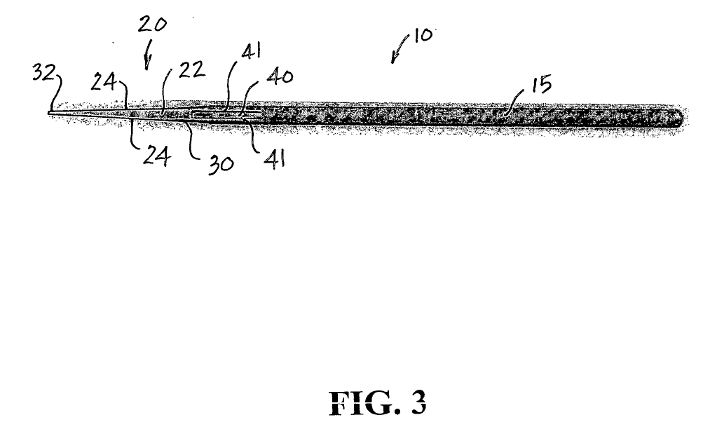

In one preferred embodiment of this invention, tip portion 20 is bendable with respect to handle portion 15. Preferably, cleaning device 10 forms or includes at least one indentation 40 formed in cleaning device 10 so that tip portion 20 is bendable with respect to handle portion 15 at the at least one indentation 40. Preferably, but not necessarily, each indentation is at least partially defined, formed or surrounded by opposing pillars or ridges 41, as shown in FIG. 3. Ridges 41 may work as a “locking notch” when cleaning device is bent as desired. The locking notch maintains cleaning device 10 in the desired bent position, when pressure is applied to cleaning device 10 during use, for example. Preferably, a plurality of indentations are formed in cleaning device 10, such as at handle portion 15, to allow cleaning device 10 to be bent in a desired position or configuration.

Referring to FIG. 2, in one preferred embodiment of this invention, at least one first indentation 45 can be formed in handle portion 15 and at least one second indentation 46 can be formed in handle portion 15 and radially offset with respect to first indentation 45 about a periphery of handle portion 15. Cleaning device 10 is bendable at first indentation 45 and/or second indentation 46 to configure cleaning device 10 as desired to properly clean a selected interdental space and/or a selected tooth surface.

Preferably, but not necessarily, second indentation 46 is radially offset with respect to first indentation by about 15° to about 75°, and more preferably about 30° to about 60°. In this embodiment, tip portion 20 can be bent with respect to handle portion 15 at first indentation 45 and bent with respect to handle portion 15 at second indentation 46 to configure cleaning device 10 to clean the interdental and/or tooth surfaces, as desired. For example, in one preferred embodiment of this invention, handle portion 15 includes two indentations 45, 46 in separate areas of handle portion 15. First indentation 45 allows the user to bend cleaning device 10 at first indentation 45 in order to position tip portion 20 to fit along a left side of the user's mouth. The user is then able to position tip portion 20 within selected interdental areas and/or along selected tooth surfaces to clean the teeth. Similarly, second indentation 46 allows the user to bend cleaning device 10 at second indentation 46 in order to position tip portion 20 to fit along an opposing right side of the user's mouth and position tip portion 20 within selected interdental areas and/or along selected tooth surfaces to clean the teeth.

Additionally or alternatively, cleaning device 10 may include a series of adjacent indentations 45, 46 formed on handle portion 15 to allow the user to make successive bends to configure cleaning device, as desired. For example, second indentation 46 can be linearly aligned with first indentation 45 so that cleaning device 10 can be bent at first indentation 45 and second indentation 46, generally in a same direction, to configure cleaning device 10 to clean the interdental and/or tooth surfaces, as desired. Cleaning device 10 can be bent at each indentation 45, 46 independently to allow handle portion 15 to be configured as desired. Bending cleaning device 10 at indentations 45, 46 allows cleaning device 10 to reach the posterior areas of the user's mouth. Additionally, the multiple bending capability of cleaning device 10 is useful for reaching the upper anterior area, as well as the lower anterior area of the user's mouth from the lingual direction.

Thus, this invention provides a cleaning device that includes a handle portion that transitions into a tip portion. The tip portion includes a back wall and two opposing tapered side walls connected at opposing side edges of the back wall. The opposing side walls converge or join to form an angled edge along a length of the tip portion. Preferably, the opposing side walls also converge from a base of the tip portion to a point of the tip portion. In one preferred embodiment of this invention, a plurality of bristles coat at least a portion of the edge and at least a portion of one or both opposing side walls, with the back wall void of bristles. Preferably, at least one indentation is formed in the cleaning device, and the tip portion is bendable with respect to the handle portion at the at least one indentation.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A cleaning device comprising:
an elongated handle;
a tip portion formed at a distal end of the elongated handle, the tip portion including a back wall and two opposing side walls each connected to the back wall, the side walls converging to form an edge along a length of the tip portion;
a plurality of bristles coating at least a portion of the edge and at least a portion of each of the opposing side walls; and
a generally smooth surface of the back wall free of bristles.

2. The cleaning device of claim 1 wherein a perpendicular distance between the back wall and the edge increases from a point of the tip portion to a base of the tip portion.

3. The cleaning device of claim 1 wherein the edge is linear.

4. The cleaning device of claim 1 wherein the edge is arcuate.

5. The cleaning device of claim 1 wherein the opposing side walls converge from a base of the tip portion to a point of the tip portion.

6. The cleaning device of claim 1 wherein the tip portion is bendable with respect to a handle portion of the cleaning device.

7. The cleaning device of claim 1 wherein the tip portion is separable from the elongated handle.

8. The cleaning device of claim 1 further comprising at least one indentation formed in the cleaning device, wherein the tip portion is bendable with respect to a handle portion of the cleaning device at the at least one indentation.

9. The cleaning device of claim 8 wherein each of the at least one indentation is at least partially formed by opposing ridges.

10. A cleaning device comprising:
a tip portion including a back wall, and two opposing tapered side walls each connected to the back wall, the tapered side walls forming an angled edge along a length of the tip portion and converging from a base of the tip portion to a point of the tip portion; and
a first indentation formed in a handle portion of the cleaning device.

11. The cleaning device of claim 10 further comprising a second indentation formed in the handle portion and radially offset with respect to the first indentation about a periphery of the handle portion.

12. The cleaning device of claim 11 further comprising a second indentation linearly aligned with the first indentation.

13. The cleaning device of claim 10 wherein the edge is coated with a plurality of bristles.

14. The cleaning device of claim 13 wherein at least a portion of each of the opposing side walls is coated with a plurality of bristles.

15. The cleaning device of claim 15 wherein the back wall is free of bristles.

16. A cleaning device comprising:
a handle portion transitioning into a tip portion, the tip portion including a back wall and two opposing tapered side walls connected to the back wall, the opposing side walls forming an angled edge along a length of the tip portion, the opposing side walls converging from a base of the tip portion to a point of the tip portion;
a plurality of bristles coating the edge and at least a portion of each of the opposing side walls, the back wall free of bristles; and
at least one indentation formed in the cleaning device, the tip portion bendable with respect to the handle portion at the at least one indentation.
